(19) United States
(12) Patent Application Publication
(10) Pub. No.: US 2018/0104879 A1
(43) Pub. Date: Apr. 19, 2018

(54) SCREW TO BE USED IN AN EXTRUDER AND EXTRUDER

(71) Applicant: Reifenhäuser GmbH & Co. KG Maschinenfabrik, Troisdorf (DE)

(72) Inventors: Mateusz SZURGOT, Köln (DE); Torsten MATHY, Köln (DE)

(21) Appl. No.: 15/786,914

(22) Filed: Oct. 18, 2017

(30) Foreign Application Priority Data
Oct. 18, 2016 (DE) 10 2016 012 478.4
Jul. 28, 2017 (DE) 10 2017 007 117.9

(51) Int. Cl. B29C 47/60; B29C 47/66

(52) U.S. Cl. CPC B29C 47/6012; B29C 47/66

(57) ABSTRACT

A screw to be used in an extruder has a modular structure so that it can be adapted very flexibly to new tasks and conditions. The modular structure of a screw contains a rod-shaped mandrel and individual screw components which are slidable onto the mandrel. The components perform the classic functions of the screw during the extrusion process, such as conveying, kneading, mixing or shearing of the plastic to be guided into and through the plant.

For transmission of the occurring high torque, the components are connected with the mandrel so that they positively engage and are axially braced in addition. The connection is to be performed such that it can be released by simple means.

### CROSS-REFERENCE TO RELATED APPLICATIONS

This application is related to and claims the benefit of German Patent Application No. 102016012478.4, filed on Oct. 18, 2016 and German Patent Application No. 102017007117.9, filed on Jul. 28, 2017, the contents of which are herein incorporated by reference in their entirety.

### TECHNICAL FIELD

The invention refers to a screw to be used in an extruder and to an extruder having such a screw. In particular, the invention refers to a screw to be used in a multiple-screw extruder and to a multiple-screw extruder itself, the screw having a mandrel and a segment of the screw which is borne by the mandrel.

### BACKGROUND

Normally, screws have a modular structure; in this manner, they can be adapted to new tasks and product properties in a very flexible manner. The modular structure of a screw has a rod-shaped core, the so called “mandrel”, and individual screw components which are slid onto the mandrel; “in praxi” the core is often also called shaft or spindle. The screw components perform the classic functions of the screw in the extrusion process, such as, for instance, conveying, kneading, mixing or shearing of the plastic to be guided into and through the plant.

For transmitting the high torque that is produced, the components are brought into positive engagement with the mandrel and are braced axially in addition. The connection is to be performed such that releasing the same is possible with simple means.

The design of a connection between a shaft and hub aims at the safe transmission of the highest possible torques between shaft and hub. For the transmission of force, a connection between shaft and hub with positive engagement has flanks which cause a deviation from the ideal geometry for transmitting torques, which would be a round rod.

To transmit the torques by positive engagement, a round rod must be re-shaped geometrically such that, on the one hand, no excessive surface pressures occur at the flank and, on the other hand, this flank does not weaken the round rod to an undesirable degree due to the occurring notch effect. These requirements conflict with each other.

DE 90 10 606 U1 describes a plug-in unit for a first shaft having a shank, at one end of which a plug-in portion is provided, with protrusions and recesses extending on the outer surface, distributed evenly over the circumference, where convex and concave shapes alternate; which shank is intended to be plugged into a hollow cylindrical receptacle of a second shaft on whose inner surface protrusions and recesses are formed which extend in parallel to the longitudinal axis of the second shaft, are distributed evenly over its circumference and blend in with each other.

From DE 38 13 272 C2, a toothed shaft connection for rigidly connecting a rotor with a shaft is known.

WO 87/01165 A1 discloses a link joint consisting of a first drive element at the end of a first rotatable shaft and a second drive element at the end of a second rotatable shaft, whose drive elements are in hinged engagement with one another.

EP 0 767 325 A2 describes a shaft gear box for transmitting a torque via a toothed shaft connection.

DE 103 30 530 A1 discloses a toothed shaft connection onto which a sleeve is welded. The screw shaft is provided with outer teeth onto which the screw components, which have corresponding inner teeth, are threaded. The components are threaded onto the sleeve up to the stopping point.

DE 196 21 571 C2 and DE 10 2004 042 746 B4 disclose toothed shaft connections between the segments of an extruder screw and the mandrel of the extruder.

DE 10 2004 056 642 A1 discloses a positive engagement between shaft and hub where the contour of the connection can be represented by epitrochoid curves.

DE 10 2006 029 471 A1 and DE 10 2011 112 148 A1 describe a spline shaft connection between the segments of an extruder screw and the mandrel of the extruder.

The invention is based on the task of providing the state of the art with an improvement or an alternative.

### SUMMARY

In a first aspect of the invention, the task is solved by a screw to be used in an extruder, the screw having a mandrel and a segment borne by the mandrel, the segment and the mandrel having a cyclically asymmetric profile shaft connection.

Some terminology will be explained in the following:

First, it is explicitly pointed out that within the context of the present patent application, indefinite articles and numerals such as “one”, “two” etc. are normally to be understood as indicating a minimum, that is, “at least one . . . ”, “at least two . . . ” etc., unless it is clear from the context or is obvious to the person skilled in the art or indispensable from a technical point of view that only “exactly one . . . ”, “exactly two . . . ” etc. are intended.

The “mandrel” is to be understood as extending, in any case, from the end of the first segment to the beginning of the last segment, in the axial direction. Application of the torque on the screw is possible either via the mandrel—in this case, a tangential fixation between the gearbox main drive pinion and the mandrel is necessary—or via a connection of the gearbox main drive pinion with at least one segment, preferably with the first segment in the axial direction, which connection transmits the torque.

The “segments” are those components of the screw which together form the spiral or the plurality of spirals for plastification of the plastic to be guided through the extruder in cooperation with the housing/cylinder of the extruder, and/or which form a kneading element and/or a conveying element.

Every two axially adjacent segments axially abut against each other at their segment borders, either directly—in the case of directly adjacent segments—or indirectly—in the case of one or more segments between them. The slot produced between them, that is, in the simplest case, an annulus, must be sealed against the penetration of plastic melt towards the inside, that is, towards the mandrel. The segments are normally braced axially for this purpose. The normal force leads to sufficient sealing by surface pressure.

A screw comprising only one segment and a mandrel, however, is also conceivable. In this case, a “segment” is the screw component which contains the spiral or the plurality of spirals for plastification of the plastic to be guided through the extruder in cooperation with the housing or cylinder of the extruder, and which may also contain a kneading component.

In the state of the art, various “profile shaft connections” are known. Profile shaft connections are all connections between shaft and hub with positive engagement. In profile shaft connections, a cross-section through the shaft generally has a symmetrical profile with parallel carriers and the hub as a counterpart thereto. With this configuration, feather keys or wedges are not necessary. The profile shaft connections can be, for instance, shafts with splined locking, toothed shafts with serration and involute toothing as well as polygonal profile shaft connections which are characterized by low notch effects.

In addition to the differences between various profile shaft connections which have already been mentioned, all different types can be further specified in terms of the symmetry of configuration. Specifications concerning axial symmetry, point symmetry, symmetry of rotation and cyclic geometry are possible.

A geometry is called “axially symmetric” and has an “axial symmetry” if it can be mapped upon itself by vertical axial reflection at its axis of symmetry.

A geometry is called “point-symmetric” and has a “point symmetry” if it can be mapped upon itself by reflection at a point of symmetry.

A geometry is called “rotationally symmetric” and has a “symmetry of rotation” if a rotation by any angle about any point or any axis causes the object to be mapped upon itself.

A geometry is called “cyclically symmetric” and has a “cyclic symmetry” if there is a rotational axis for the object and the object comprises a sector which is repeated multiple times with reference to the axis. At the border of the sectors, both neighboring sectors must have equal contours.

Cyclically symmetric objects can be further subdivided into cyclically symmetric objects whose sectoral border extends and runs radially on a straight line or a polygonal line or on a curve.

Cyclically symmetric objects with a radial sectoral border can have an axial symmetry and/or a point symmetry in addition.

A geometry is called “cyclically asymmetric” and has a “cyclic asymmetry” if it is not cyclically symmetric. In other words, all geometries are cyclically asymmetric if the object has an axis of rotation and is not composed of multiple repetitive sectors with reference to this axis.

A “screw segment” is a cyclically symmetric portion of the screw with respect to the screw axis in a cross-section of the screw which is perpendicular to the screw axis.

In the context of this invention, the term “cyclic symmetry” is to be understood as a local term which can refer either to the symmetry of the connection between shaft and hub, that is, to the profile shaft connection between mandrel and segment, or, possibly with a slightly different meaning, to the symmetry of the screw segments. The screw geometry comprises, for instance, the number of spirals, the conformation of the kneading components and other aspects which together affect the geometry of the screw segments.

Normally, the screw geometry has a cyclically symmetric configuration. Thus, in a specific case, it is conceivable that the screw segments may have a cyclic symmetry but that at the same time the connection between mandrel and segment may be cyclically asymmetric.

Until now, the state of the art has envisaged only cyclically symmetric profile connections for connecting a mandrel with a segment of an extruder screw.

In contrast, it is proposed herein to use cyclically asymmetric profile connections.

In this manner, with suitable design, the segments can be assembled on the mandrel in a more limited number of circumferential positions.

For instance, it is conceivable that a segment can only be pushed on the mandrel in one, two or three etc. predefined circumferential positions. In this manner, it can be ensured that the segments of a screw are adjacent only in the desired circumferential positions. These preferred mounting positions can depend, for instance, on the number of screw spirals and are particularly preferred in profile shaft connections with a large number of positively engaging components which would otherwise be cyclically symmetric.

In a specific case, for instance, it is conceivable to modify an otherwise cyclically symmetric configuration of a polygonal shaft connection, a spline shaft connection or a toothed shaft connection by providing one sector of the profile shaft connection with a different geometry than the other sectors, thus creating a cyclically asymmetric connection between the mandrel and the segments.

Another embodiment provides for adapting the cyclic asymmetry of the connection between mandrel and segment to the symmetry characteristics of the screw such that there are exactly as many possible combinations of assembling the segment and the mandrel as there are cyclically symmetric screw segments, and such that the symmetry between mandrel and segment is adapted to the symmetry of the screw segment in such a way that no functional characteristics of the extruder screw can be impaired by a faulty mounting angle between the screw and the mandrel.

Advantageously, in this manner, the configuration of the profile shaft connection between the mandrel and the segment can help avoid a faulty assembly.

Also, it can advantageously be achieved in this manner that neighboring segments can only be assembled in such a way that they are adjusted to each other and correspond with the intended functionality of the screw of the extruder and that a faulty assembly of several consecutive segments is excluded.

Optionally, the profile shaft connection has a whole multiple of local maximum values of the radius of the connection between the mandrel and the screw as compared to the cyclically symmetric screw segments.

Some terminology will be explained in the following:

A “local maximum” means that the radius of the contour of the profile shaft connection reaches a local maximum value at the point of the local maximum, and that in the neighborhood of the local maximum, the radius assumes no values which are larger than that of the maximum. The opposite of the local maximum is the “local minimum”.

Advantageously, in this manner, several suitable combinations of the peripheral angles of the mandrel and of the segment can be achieved which can ensure, with suitable configuration, that the individual adaptation between adjacent segments or between functionalities of the extruder screw and the extruder housing is always achieved without any errors.

Preferably, the profile shaft connection has a contour with two profile flanks, the extruder screw having a direction of rotation, determined by construction, wherein a profile flank, in particular, the profile flank of the mandrel which faces the segment in the direction of rotation, is steeper in the radial direction than the other profile flank.

Some terminology will be explained in the following:

A “profile flank” is the connection, on the contour of the profile shaft connection, between a local minimum and a local maximum of the radius of the profile shaft connection contour.

A “direction of rotation determined by construction” is the rotational direction of the screw during normal operation of the extruder, wherein the material to be processed is conveyed from the feed opening to the outlet of the extruder.

Advantageously, in this manner, the radial forces acting on the mandrel can be reduced. The profile flank of the mandrel facing the segment in the direction of rotation assumes the task of applying the torque produced by the extruder drive from the mandrel on the screw. Preferably, no additional load is to be applied on the mandrel in the radial mandrel direction when the torque is transmitted. The steeper the profile flank of the mandrel which faces the segment in the direction of rotation, the lower the radial forces that are applied on the mandrel and the higher the desirable tangential forces; the efficiency in transmission of the torque can be increased in this manner.

The profile flank of the mandrel facing the segment in the direction of rotation is advantageously flat. In this manner, the forces from the profile flank which transmits the torque from the mandrel to the segment can be better applied on the mandrel with less notch effects.

In a second aspect of the invention, the task is solved by a screw to be used in an extruder, the screw having a mandrel and a segment borne by the mandrel; the segment and the mandrel being connected by a profile shaft connection which is a polygonal profile shaft connection with curved flanks.

Some terminology will be explained in the following:

A “polygonal profile shaft connection” is a profile shaft connection which is defined by its characteristic polygonal shape and belongs to a type of connections called “out-of-roundness” connections. They belong to those connections which are detachable and can slide axially. According to DIN 32711, various types and dimensions of “polygonal shafts” are categorized. This categorization, however, is not necessarily exhaustive, and additional embodiments of polygonal shafts may be comprised by this term, in particular under this aspect of the invention.

A “flank” is the connection on the contour of the polygonal shaft connection between the points of the polygon.

The term “curved flanks” means that the flanks are no straight connections but rather defined by curves, wherein curved flanks have curves over at least 75% of their lengths.

Until now, the state of the art did not envisage polygonal shaft connections for the profile shaft connection between the mandrel and the segment of an extruder screw.

In derogation from the state of the art, such connections are proposed here.

Advantageously, in this manner, the polygonal shaft connection can transmit very high torques, in particular high torques with high temporal dynamics.

In addition, a polygonal shaft connection can be assembled very easily and, thanks to its conformation, has very low notch effects, increasing material utilization.

As a whole, a polygonal shaft connection can transmit torques very efficiently and with its easy assembly, leads to an embodiment of a connection between shaft and hub for an extruder screw.

It is explicitly pointed out that the subject matter of the second aspect can advantageously be combined with the subject matter of the first aspect of the invention.

Preferably, a flank has a convex curve facing the segment.

Advantageously, in this manner, the notch effect of the polygonal shaft connection can be reduced.

Optionally, a flank can have a concave curve facing the segment.

Advantageously, in this manner, the torques can be transmitted at steeper flanks, causing lesser radial forces to act on the polygonal shaft connection and increasing the efficiency of torque transmission.

Preferably, the mandrel has a polygonal contour, the polygonal contour being harmonic.

Some terminology will be explained in the following:

All types of profile connections, including the profile shaft connections proposed in the other aspects, can be subdivided into profile connections with harmonic and disharmonic profiles.

A profile connection has a “harmonic contour” if the contour is continuous and differentiable at every point.

A profile connection has a “disharmonic contour” if the contour is continuous but not always differentiable at every point.

Advantageously, in this manner, the notch effect can be further reduced over the entire circumference of the polygonal shaft connection by means of the rounded edges, increasing material utilization.

Optionally, the mandrel can have a polygonal contour which is disharmonic.

Advantageously, in this manner, depending on the embodiment of the disharmony, the assembly can be facilitated, the peripheral angle between the mandrel and the segment can be clearly assigned, notch effects can be locally reduced and the efficiency of transmission of the torque can be increased.

In a third aspect of the invention, the task is solved by a screw to be used in an extruder, the screw having a mandrel and a segment borne by the mandrel, the segment and the mandrel being connected by a profile shaft connection and the profile shaft connection being a spline shaft connection.

Some terminology will be explained in the following:

A “spline shaft connection” is a profile shaft connection which produces a positive engagement with the hub by means of a plurality of carriers with straight and parallel flanks. Different types of connections and their dimensions are categorized according to DIN 5464, DIN 5471, DIN 5472 and DIN ISO 14. This categorization, however, is not necessarily exhaustive, and additional embodiments of spline shafts may be comprised by this term, especially under this aspect of the invention. The respective embodied shaft-hub connection is a “spline shaft connection”.

Until now, the state of the art did not envisage spline shaft connections for the profile shaft connection between the mandrel and the segment of an extruder screw.

In derogation from the state of the art, such connections are proposed here.

Advantageously, in this manner, a very inexpensive profile shaft connection can be employed which is already used in a plurality of other applications. Therefore, many experiences have already been gained concerning the transmission of a torque by means of a spline shaft connection, which experiences can be made use of during design and can lead to an overall improved connection between shaft and hub.

Also, there are standardized tools for the manufacturing of spline shaft connections so that the production can be relatively inexpensive.

Furthermore, the parallel and very steep flanks of a spline shaft connection can help to transmit torques very efficiently, that is, without strong radial forces in the connection, which leads to a very good material utilization.

It is explicitly pointed out that the subject matter of the third aspect can advantageously be combined with the subject matter of the above aspects of the invention, either individually or in a cumulative manner in any combination.

In a fourth aspect of the invention, the task is solved by a screw to be used in an extruder, the screw having a mandrel and a segment borne by the mandrel, the segment and the mandrel having a profile shaft connection in the form of an axially asymmetric toothed shaft connection with one tooth, the tooth having a right and a left tooth flank each of which has a curvature.

Some terminology will be explained in the following:

A “toothed shaft connection” is a profile shaft connection which establishes a positive engagement with the hub by a plurality of teeth. Tooth engagements with a level tooth flank, in particular a tooth flank with a constant pressure angle of the teeth, are distinguished from tooth engagements with a curved tooth flank, especially one with involute toothing. Various types of connections and their dimensions are categorized according to DIN 5480. This categorization, however, is not necessarily exhaustive, and additional embodiments of toothed shafts may be comprised by this term, especially under this aspect of the invention. The shaft-hub connection executed accordingly is a “toothed shaft connection”.

“Involute toothing” is a tooth engagement with a particular form of an involute. The shape of the involute is defined by a number of geometrical requirements on the tooth-profile geometry.

A “tooth flank” is a geometric connecting line between the root circle and the tip circle of a tooth.

A “root circle” is the circle on which the lowest point of the toothing in the radial direction lies. The corresponding diameter is called “root circle diameter”.

A “tip circle” is the circle on which the highest point of the toothing in the radial direction is located. The corresponding diameter is called “tip circle diameter”.

An “axially asymmetric toothed shaft connection” is a toothed shaft connection in which the teeth have no axial symmetry. In other words, a first tooth flank of an axially asymmetric toothed shaft connection cannot be mapped by reflection of a second profile at an axis.

Until now, the state of the art for the most part provided for the geometry of the teeth of toothed shaft connections between the mandrel and the segment of an extruder screw to be axially symmetric. Thus, DE 196 21 571 C2 discloses a toothed shaft connection with axially symmetric teeth.

DE 10 2004 042 746 B4 discloses an axially asymmetric toothed shaft connection between the mandrel and the segment of an extruder screw, the areas of the tooth flanks where the mandrel and the segment contact each other being planar.

In derogation from the state of the art, it is proposed to configure the tooth flanks in the contact area not to be planar but to have a continuous curvature.

Thus, it is conceivable, for instance, that the contour of the mandrel is designed such within the framework of the conditions mentioned below that the notch effect can be reduced, a sufficiently large number of teeth is used for distributing the force over the circumference and for reducing the surface pressure and such that the shape of the profile facing the segment in the direction of rotation is such that as far as possible no radial forces but maximum possible tangential forces are produced when the torque is transmitted.

In a preferred embodiment, the tooth flanks are constructed from cycloids and/or hypocycloids which exhibit a very good notch stress behavior.

In another advantageous embodiment, it is conceivable that the tooth flank facing the segment in the direction opposite to the direction of rotation is removed and/or provided with a circular contour.

Thus, it is conceivable, for instance, that the cycloid tooth contour profiles the toothed shaft connection harmonically over its circumference.

Advantageously, it can be achieved in this manner that the tooth flank not bearing a load is used for reducing the notch effect. Due to the asymmetric structure, the notch effect can be reduced even more without impairing the torque transmission, since there is only one preferred direction anyway.

The tooth flank bearing the load is formed curved, which allows, with suitable design, a reduction of the notch effect at the tooth root.

The tooth flanks are designed asymmetric because, among other reasons, the mandrel turns in one direction of rotation. The advantage of this type of transmission is that the maximum lever arm can be used to transmit minimal forces at the circumference.

The removal of the non-load-bearing profile can improve the notch behavior in the tooth. For the torsional forces, removal of the non-load-bearing profile can have the same effect as a relief notch, without impairment of the functionality since there is a preferred direction of rotation.

As a whole, with suitable design, the proposed toothed shaft connection can help to reduce notch stresses and radial forces in the mandrel and in the segment, can improve material utilization and the efficiency of torque transmission.

It is explicitly pointed out that the subject matter of the fourth aspect can advantageously be combined with the subject matter of the above aspects of the invention, either individually or in a cumulative manner in any combination.

Preferably, a tooth segment has a tooth contour which is harmonic.

Advantageously, in this manner, the rounded edges over the entire circumference of the polygonal shaft connection can help to further reduce the notch effect, improving material utilization.

Optionally, the tooth segment has a tooth contour which is disharmonic.

Advantageously, in this manner, depending on the embodiment of the disharmony, the assembly can be facilitated, the peripheral angle between the mandrel and the segment can be clearly assigned, notch effects can be locally reduced and the efficiency of transmission of the torque can be increased.

In a fifth aspect of the invention, the task is solved by a screw to be used in an extruder, the screw having a mandrel and a segment borne by the mandrel, the segments and the mandrel being connected by a cyclically symmetric profile shaft connection, wherein the profile shaft connection is an axially asymmetric toothed shaft connection and a tooth pitch has a tooth contour, with the tooth contour of the mandrel deviating from a fifth-degree polynomial in the direction perpendicular to the contour by maximally one hundredth of a tip circle diameter of the mandrel.

Some terminology will be explained in the following:

A “tooth pitch” is understood as a cyclically symmetric portion of a cyclically symmetric toothed shaft connection and as the aperture angle of a cyclically symmetric tooth segment.

A “tooth segment” is a cyclically symmetric portion of the toothed shaft connection with respect to the axis of the screw in a cross-section of the screw which is perpendicular to the screw axis; in particular, the left and the right limitation point of a tooth segment are located on the tip circle diameter.

A “contour normal” is understood as being perpendicular to the contour.

A “tooth contour” is the contour of a tooth segment.

With suitable design of the contour of a tooth segment, it is described by a fifth-degree polynomial within narrow tolerance limits of one hundredth of the tip circle diameter.

Advantageously, in this manner, it can be achieved that the tooth contour is well-rounded, has only little notch effects and is therefore suitable for optimizing the material utilization of the toothed shaft connection.

It is explicitly pointed out that the above-mentioned tolerance values are not to be understood as strict limits but can be higher or lower than indicated, on an engineering scale, without leaving the described aspect of the invention. In other words, the values are intended to form points of reference for the size of the range of tolerance proposed here.

It is explicitly pointed out that the subject matter of the fifth aspect can advantageously be combined with the subject matter of the above aspects of the invention, either individually or in a cumulative manner in any combination.

Preferably, a left point of a tooth contour is described by the polynomial, the left point being located on the tip circle diameter of the mandrel and bordering on the left flank of a first tooth.

Preferably, a right point of a tooth contour is described by the polynomial, the right point being located on the tip circle diameter of the mandrel and bordering on the left flank of a second tooth.

Preferably, a lowest point of a tooth contour is described by the polynomial, the point being located on a root circle diameter of the mandrel within a range between 55% and 90%, preferably within a range between 65% and 83% and particularly preferably within a range between 75% and 79% in the circumferential direction on a radius between the radius of the left point and the radius of the right point.

It is explicitly pointed out that the above-mentioned values of the position of the lowest point are not to be understood as strict limits but can be higher or lower than indicated, on an engineering scale, without leaving the described aspect of the invention. In other words, the values are intended to form points of reference for the position of the lowest point.

Preferably, at the left point, the gradient of the radius in the direction of circumference lies within a range between −0.1 and 0.1, preferably between −0.05 and 0.05 and particularly preferably has a value of 0.

It is explicitly pointed out that the above-mentioned values of the gradient at the left point are not to be understood as strict limits but can be higher or lower than indicated, on an engineering scale, without leaving the described aspect of the invention. In other words, the values are intended to form points of reference for the gradient of the left point.

Preferably, at the lowest point, the gradient of the radius in the direction of circumference has a value of 0.

Preferably, at the right point, the gradient of the radius in the direction of circumference lies within a range between 10 and ∞, preferably between 100 and ∞ and particularly preferably has a value of ∞.

It is explicitly pointed out that the above-mentioned values of the gradient at the right point are not to be understood as strict limits but can be higher or lower than indicated, on an engineering scale, without leaving the described aspect of the invention. In other words, the values are intended to form points of reference for the gradient of the right point.

In a sixth aspect of the invention, the task is solved by a screw to be used in an extruder, the screw having a mandrel and a segment borne by the mandrel, the segment and the mandrel having a profile shaft connection with a disharmonic contour and the profile shaft connection having an axially symmetric contour, the contour of the mandrel having a concave recess with a harmonic contour, in contrast to an otherwise cylindrical surface area of the mandrel; wherein the harmonic contour of the recess is connected to the otherwise cylindrical mandrel surface area by a disharmonic transition area at the tip circle of the mandrel.

Some terminology will be explained in the following:

A “mandrel surface area” is the surface area of a cylindrical mandrel, that is, the surface of a mandrel which is created by rotation of a graph of a function about a mandrel's longitudinal axis.

A “recess” is each geometrical change which alters an otherwise cylindrical mandrel surface area in such a way that the mandrel surface area is interrupted by the recess. In other words, the otherwise cylindrical mandrel is deepened by the recess at the place of the recess.

A “transition area” is the place on the otherwise cylindrical mandrel surface area where the otherwise cylindrical mandrel surface area transitions to a recess. In other words, the recess of an otherwise cylindrical mandrel surface area starts in the transition area. If the contour path in the transition area is not differentiable, the area is a “disharmonic transition area”.

In a specific case, it is conceivable, for instance, that a mandrel has a recess with a harmonic contour which in the transition area disharmonically transitions to the otherwise cylindrical mandrel surface area.

Advantageously, this aspect of the invention can achieve that a profile-shaft connection has only very low notch stresses even if high torques are transmitted.

Furthermore, it can advantageously be achieved by this aspect of the invention that the mandrel of a profile shaft connection has a particularly high section modulus which allows a reduction of the profile shaft connection diameter.

Optionally, the profile shaft connection is cyclically symmetrical.

Advantageously, in this manner, the cyclic geometry of the profile shaft connection can result in various possible mounting angles between a mandrel and a segment borne by the mandrel, which allows many possible mounting options.

Preferably, the harmonic contour of the recess corresponds to a portion of a contour of an ellipse.

Some terminology will be explained in the following:

A “portion” is understood to be a segment of a geometry which in particular forms a recess. The portion can be any portion of a geometry which contains a part of the original border of the geometry. This part of the original border of the portion of a geometry maps the contour of a recess. In particular, a recess can be a portion of an ellipse, a circle or a polygon.

Advantageously, this aspect of the invention can achieve a profile shaft connection which has very minor notch stresses even if high torques are transmitted, wherein at the same time the comparatively shallow recess of the mandrel leads to a high section modulus of the mandrel so that a profile shaft connection requires a smaller necessary diameter. This may help to save material and to allow the screw core, which is substantially formed by the mandrel, to have an optimally smaller diameter, so that the flight depth of a screw can be increased while the outer screw diameter remains the same.

The harmonic contour of the recess can optionally correspond to a portion of a circle contour.

Advantageously, this aspect of the invention can achieve a profile shaft connection which has very minor notch stresses even if high torques are transmitted, wherein at the same time the comparatively shallow recess of the mandrel leads to a high section modulus of the mandrel so that a profile shaft connection requires a smaller necessary diameter. This may help to save material and to allow the screw core, which is substantially formed by the mandrel, to have an optimally smaller diameter, so that the flight depth of a screw can be increased while the outer screw diameter remains the same.

Preferably, the harmonic contour of the recess corresponds to a portion of a polygon.

Advantageously, by this aspect of the invention a profile shaft connection can be achieved which has very minor notch stresses even if high torques are transmitted, wherein at the same time the comparatively shallow recess of the mandrel leads to a high section modulus of the mandrel so that a profile shaft connection requires a smaller necessary diameter. This helps to save material and allows the screw core, which is substantially formed by the mandrel, to have an optimally smaller diameter so that the flight depth of a screw can be increased while the outer screw diameter remains the same.

It is explicitly pointed out that the subject matter of the sixth aspect can advantageously be combined with the subject matter of the above aspects of the invention, either individually or in a cumulative manner in any combination.

Optionally, the mandrel has an undercut proximate to the root circle diameter.

Advantageously, with suitable design, it can be achieved in this manner that the undercut reduces the notch effect at the tooth root of the mandrel.

Optionally, the segment has an undercut proximate to the root circle.

Advantageously, with suitable design, it can be achieved in this manner that the undercut reduces the notch effect at the tooth root of the segment.

Preferably, the mandrel and the segment each have a tip circle diameter and a root circle diameter, the tip circle diameter of the segment being larger than the root circle diameter of the mandrel.

Advantageously, in this manner, double fits can be avoided and the functionality of the toothed shaft connection can be guaranteed.

Optionally, the mandrel and the segment each have a tip circle diameter and a root circle diameter, the root circle diameter of the segment being larger than the tip circle diameter of the mandrel.

Advantageously, in this manner, double fits can be avoided and the functionality of the toothed shaft connection can be guaranteed.

Preferably, the profile shaft contour of the segment is radially larger by at the most one hundredth of the tip circle diameter of the mandrel; more preferably, by at the most one thousandth.

Advantageously, in this manner, double fits can be avoided and the functionality of the toothed shaft connection can be guaranteed.

In addition, this allows a close sliding fit between the mandrel and the segment which facilitates assembly and disassembly but at the same time does not allow a large play which would be detrimental to the functionality of the connection between shaft and hub.

Optionally, the profile-shaft contour has edges which are rounded.

Advantageously, in this manner, no overload will be caused on the edges by too high local surface pressures, and thus the functionality of the toothed shaft connection can be guaranteed.

Also, the rounded edges can reduce the risk of injury.

Furthermore, the rounded edges can help to reduce the notch effect.

In a seventh aspect of the invention, the task is solved by an extruder in which a screw proposed here is employed.

It is understood that the advantages of a screw as described above extend directly to an extruder, in particular to a single-screw extruder or to a multiple-screw extruder having a screw as described above.

It is explicitly pointed out that the subject matter of the seventh aspect can advantageously be combined with the subject matter of the above aspects of the invention, either individually or in a cumulative manner in any combination.

### BRIEF DESCRIPTION OF THE DRAWINGS

In the following, the invention will be explained in more detail by means of two examples of embodiment with reference to the drawings wherein:

FIG. 1 schematically shows a cross-section of a screw to be used in an extruder, the screw having a cyclically asymmetric profile shaft connection with positive engagement,

FIG. 2 schematically shows a cross-section of a screw to be used in an extruder, the screw having a polygonal shaft connection with positive engagement, having a disharmonic polygonal contour with convexly curved polygonal flanks,

FIG. 3 schematically shows a cross-section of a screw to be used in an extruder, the screw having an axially asymmetric toothed shaft connection with positive engagement, having a disharmonic shaft contour and a harmonic tooth contour, and

FIG. 4 schematically shows a cross-section of a screw to be used in an extruder, the screw having a profile shaft connection to a mandrel with concave recesses, wherein the contour of the recesses is harmonic.

### DETAILED DESCRIPTION OF THE DRAWINGS

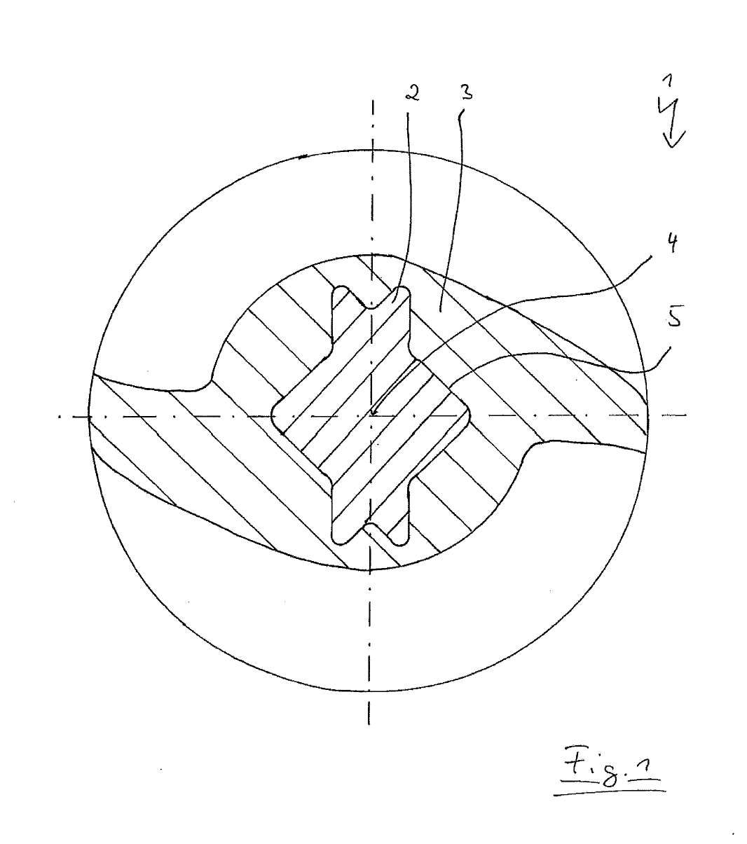

The extruder screw 1 in FIG. 1 has a mandrel 2 and a segment 3. The extruder screw can rotate about an axis 4 for conveying, kneading, mixing or shearing a plastic.

The mandrel 2 and the segment 3 are interconnected by a releasable profile shaft connection with positive engagement, wherein the segment 3 can be axially slid onto the mandrel 2.

The profile shaft connection of the extruder screw 1 is cyclically asymmetric and has a mandrel profile 5.

The extruder screw 1 has two spirals. The cyclically asymmetric profile shaft connection is designed such that the segment 3 cannot be slid onto the mandrel circumference at a faulty angle, which in turn ensures that the adjacent segments also cannot be positioned at a non-fitting peripheral angle.

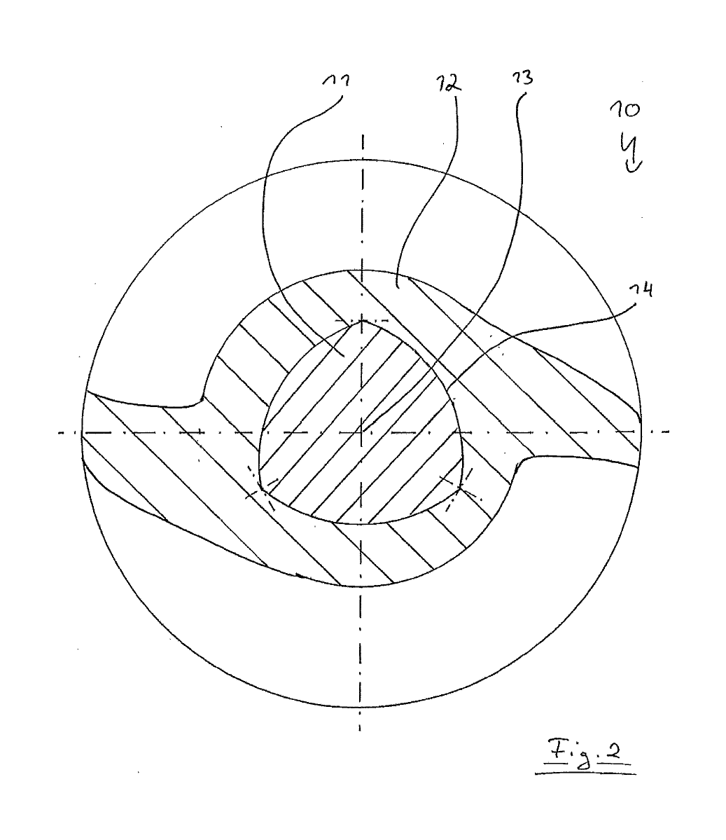

The extruder screw 10 in FIG. 2 has a mandrel 11 and a segment 12. The extruder screw 10 can rotate about an axis 13 for conveying, kneading, mixing or shearing a plastic.

The mandrel 11 and the segment 12 are interconnected by a releasable polygonal shaft connection with positive engagement, wherein the segment 12 can be axially slid onto the mandrel 11.

The polygonal shaft connection of the extruder screw 10 is cyclically symmetric and has a disharmonic polygonal profile 14 with convexly curved flanks.

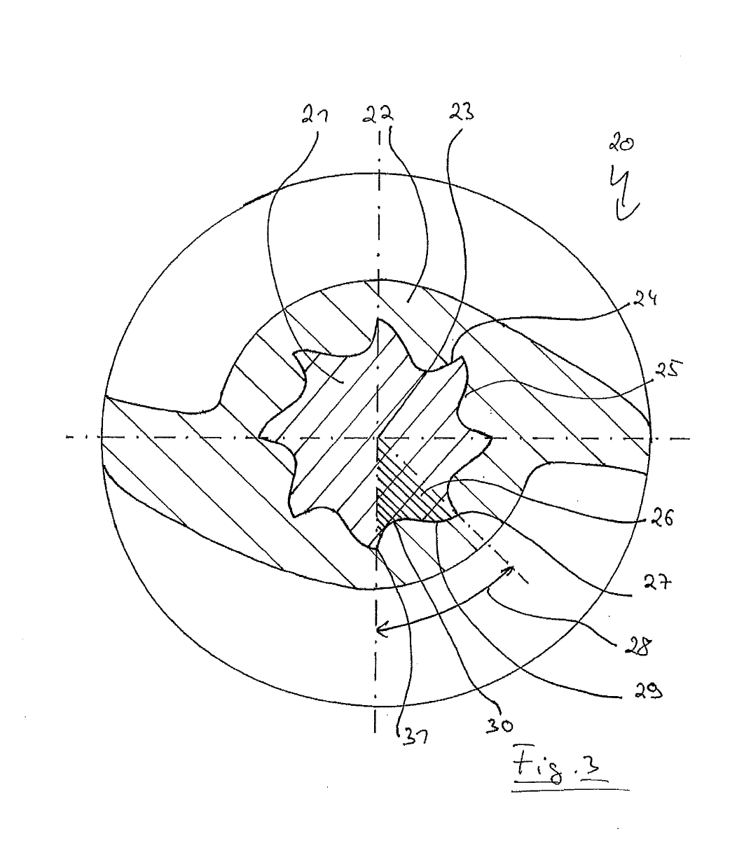

The extruder screw 20 in FIG. 3 has a mandrel 21 and a segment 22. The extruder screw 20 can rotate about an axis 23 for conveying, kneading, mixing or shearing.

The mandrel 21 and the segment 22 are interconnected via a positively engaging, axially asymmetric, releasable toothed shaft connection wherein the segment 22 can be slid axially onto the mandrel 21.

The toothed shaft connection of the extruder screw 20 has a cyclically symmetric tooth pitch 28 and a disharmonic profile.

Each tooth segment 26 has a left tooth flank 24 and a right tooth flank 25. The transition between the left tooth flank 24 and the right tooth flank 25 is at the lowest point 30 of the tooth contour 29.

The tooth contour 29 of each cyclically symmetric tooth segment 26 starts at a left point 27, leads to the lowest point 30 via the right tooth flank 25 and to the right point 31 via the left tooth flank 24.

The left tooth flank 24 and the right tooth flank 25 have a curved contour.

The left tooth flank 24 and the right tooth flank 25 are asymmetric.

The left tooth flank 24 has a steeper contour than the right tooth flank 25.

The mandrel preferably rotates in the direction of the steeper tooth flank. In this embodiment, this is the direction of the left tooth flank 24. That is, in this embodiment, the preferred direction of rotation is counterclockwise.

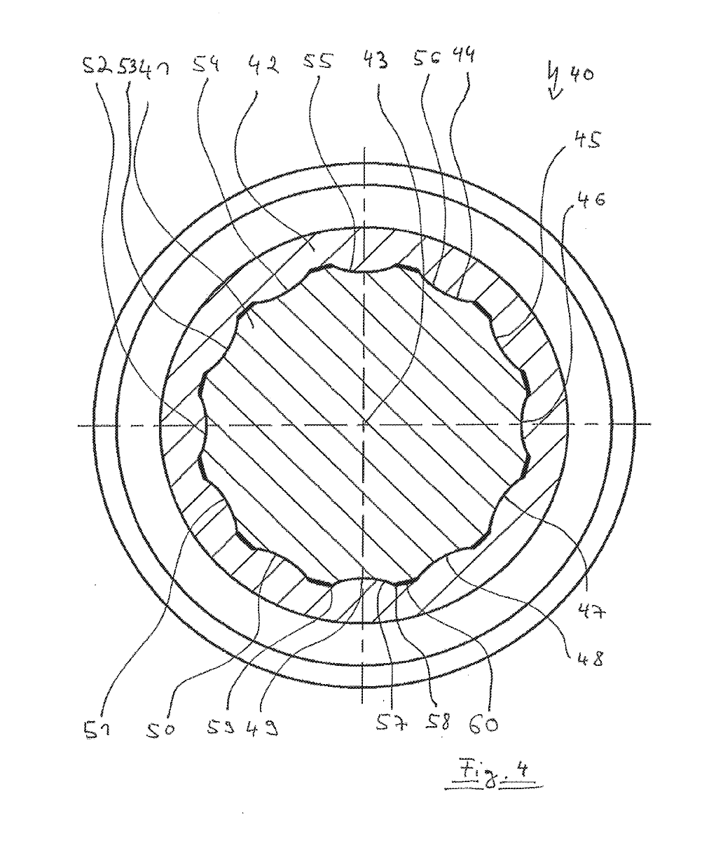

The extruder screw 40 in FIG. 4 has a mandrel 41 and a segment 42. The extruder screw 40 can rotate about an axis 43 for conveying, kneading, mixing or shearing of a plastic.

The mandrel 41 and the segment 42 are interconnected via a positively engaging releasable profile shaft connection, wherein the segment 42 can be axially slid onto the mandrel 41.

The profile shaft connection of the extruder screw 40 is cyclically symmetric and has twelve recesses 45, 46, 47, 48, 49, 50, 51, 52, 53, 54, 55, 56.

The recesses 45, 46, 47, 48, 49, 50, 51, 52, 53, 54, 55, 56 have a harmonic concave contour 57 with a disharmonic transition to the else cylindrical mandrel surface area 60 at the transition points 58, 59.

1. Screw to be used in an extruder, the screw having a mandrel and a segment borne by the mandrel,
characterized in that
the segment and the mandrel have a cyclically asymmetric profile shaft connection.

2. Screw according to claim 1, characterized in that the profile shaft connection has a whole multiple of local maximum values of the radius of the connection between the mandrel and the screw as compared to the cyclically symmetric screw segments.

3. Screw according to one of claim 1 or 2, the profile shaft connection having a contour with two profile flanks, the extruder screw having a direction of rotation determined by construction, characterized in that one profile flank, in particular the profile flank of the mandrel which faces the segment in the direction of rotation, is steeper in the radial direction than the other profile flank.

4. Screw to be used in an extruder, the screw having a mandrel and a segment borne by the mandrel, with the segment and the mandrel having a profile shaft connection,
in particular screw according to one of the above claims, characterized in that
the profile shaft connection is a polygonal profile shaft connection with curved flanks.

5. Screw according to claim 4, characterized in that a flank is convexly curved in the direction of the segment.

6. Screw according to one of claim 4 or 5, characterized in that a flank is concavely curved in the direction of the segment.

7. Screw according to one of claims 4 through 6, the mandrel having a polygonal contour, characterized in that the polygonal contour is harmonic.

8. Screw according to one of claims 4 through 6, the mandrel having a polygonal contour, characterized in that the polygonal contour is disharmonic.

9. Screw to be used in an extruder, the screw having a mandrel and a segment borne by the mandrel, the segment and the mandrel having a profile shaft connection,
in particular screw according to one of claims 1 through 3, characterized in that
the profile shaft connection is a spline shaft connection.

10. Screw to be used in an extruder, the screw having a mandrel and a segment borne by the mandrel, the segment and the mandrel having a profile shaft connection and the profile shaft connection being embodied in the form of an axially asymmetric toothed shaft connection with one tooth, the tooth having a right and a left tooth flank,
in particular screw according to one of claims 1 through 3, characterized in that
the tooth flanks have a curvature.

11. Screw according to claim 10, a tooth segment having a tooth contour, characterized in that the tooth contour is harmonic.

12. Screw according to claim 10, a tooth segment having a tooth contour, characterized in that the tooth contour is disharmonic.

13. Screw to be used in an extruder, the screw having a mandrel and a segment borne by the mandrel, the segments and the mandrel being connected by a cyclically symmetric profile shaft connection, wherein the profile shaft connection is an axially asymmetric toothed shaft connection, a tooth pitch having a tooth contour,
in particular screw according to one of the above claims, characterized in that
the tooth contour of the mandrel deviates from a fifth-degree polynomial in the direction perpendicular to the contour by maximally one hundredth of a tip circle diameter of the mandrel.

14. Screw according to claim 13, characterized in that a left point of a tooth contour is described by the polynomial, the left point being positioned on the tip circle diameter of the mandrel and the left point bordering on the left flank of a first tooth.

15. Screw according to one of claim 13 or 14, characterized in that a right point of a tooth contour is described by the polynomial, the right point being located on the tip circle diameter of the mandrel and the right point bordering on the left flank of a second tooth.

16. Screw according to one of claims 13 through 15, characterized in that a lowest point of a tooth contour is described by the polynomial, the point being located on the root circle diameter of the mandrel within a range between 55% and 90%, preferably within a range between 65% and 83% and particularly preferably within a range between 75% and 79% in the circumferential direction on a radius between the radius of the left point and the radius of the right point.

17. Screw according to one of claims 13 through 16, characterized in that at the left point, the gradient of the radius in the direction of circumference lies within a range between −0.1 and 0.1, preferably between −0.05 and 0.05 and particularly preferably has a value of 0.

18. Screw according to one of claims 13 through 17, characterized in that at the lowest point, the gradient of the radius in the direction of circumference is 0.

19. Screw according to one of claims 13 through 18, characterized in that at the right point, the gradient of the radius in the direction of circumference lies within a range between 10 and ∞, preferably between 100 and ∞ and particularly preferably has a value of ∞.

20. Screw to be used in an extruder, the screw having a mandrel and a segment borne by the mandrel, the segment and the mandrel having a profile shaft connection with a disharmonic contour,
in particular screw according to one of the above claims, characterized in that
the profile shaft connection has an axially symmetric contour, the contour of the mandrel having a concave recess, with respect to an else cylindrical shape of a mandrel surface area, with a harmonic shape of a contour of the recess, the harmonic contour of the recess being associated with the else cylindrical shape of the mandrel surface area by a disharmonic transition at the tip circle of the mandrel.

21. Screw according to claim 20, characterized in that the profile shaft connection is cyclically symmetric.

22. Screw according to one of claim 20 or 21, characterized in that the harmonic contour of the recess corresponds to a portion of a contour of an ellipse.

23. Screw according to one of claims 20 through 22, characterized in that the harmonic contour of the recess corresponds to a portion of a contour of a circle.

24. Screw according to one of claims 20 through 23, characterized in that the harmonic contour of the recess corresponds to a portion of a polygon.

25. Screw according to one of the above claims, characterized in that the mandrel has an undercut proximate to the root-circle diameter.

26. Screw according to one of the above claims, characterized in that the segment has an undercut proximate to the root circle.

27. Screw according to one of the above claims, the mandrel and the segment each having a tip-circle diameter and a root-circle diameter, characterized in that the tip-circle diameter of the segment is larger than the root-circle diameter of the mandrel.

28. Screw according to one of the above claims, the mandrel and the segment each having a tip-circle diameter and a root-circle diameter, characterized in that the root-circle diameter of the segment is larger than the tip-circle diameter of the mandrel.

29. Screw according to one of the above claims, characterized in that the profile shaft contour of the segment is radially larger by at the most one hundredth of the tip circle diameter of the mandrel; preferably, by at the most one thousandth.

30. Screw according to one of the above claims, the profile shaft contour having edges, characterized in that the edges are rounded.

31. Extruder having a screw according to one of the above claims.
